(19) United States
(12) Patent Application Publication
(10) Pub. No.: US 2025/0011067 A1
(43) Pub. Date: Jan. 9, 2025

(54) BEVERAGE DISPENSING COOLER

(71) Applicant: Jake Kadow, Kearney, NE (US)

(72) Inventor: Jake Kadow, Kearney, NE (US)

(21) Appl. No.: 18/218,928

(22) Filed: Jul. 6, 2023

(51) Int. Cl. B65D 81/38; B65D 25/04; B65D 25/24; B65D 25/28; B65D 43/02; B65D 83/00; F25D 3/08

(52) U.S. Cl. CPC B65D 81/3813; B65D 25/04; B65D 25/24; B65D 25/2808; B65D 43/0202; B65D 83/00; F25D 3/08; B65D 2543/00194

(57) ABSTRACT

A dispensing cooler apparatus for reducing heat transfer to or from contained beverages and dispensing the beverages through a perimeter wall includes a container with a plurality of panels coupled to and positioned in the container. The plurality of panels define a plurality of slots, at least one of which is usable to store beverage vessels. A support wall supports the beverage vessels and has an aperture for facilitating passage of the beverage vessels to a dispensing member. The dispensing member has a recess sized to hold a beverage vessel and which is made accessible from outside the chamber when the dispensing member is moved to an extended position. The dispensing member also has a stopper which prevents beverage vessels from passing through the aperture when the dispensing member is in the extended position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to beverage cooler and more particularly pertains to a new beverage cooler for reducing heat transfer to or from contained beverages and dispensing the beverages through a perimeter wall.

### (2) Description of Related Art Including Information Disclosed Under 37 CFR 1.97 and 1.98

The prior art includes several examples of beverage coolers which dispense beverages through a perimeter wall. However, the devices of the prior art comprise chutes for directing the movement of the beverages toward an outlet or, at least in one case, include a chamber which is unobstructed except for a rotatable dispensing member adjacent to the outlet. The prior art fails to describe such a device which uses panels positioned in the chamber to contain the beverages and align them with a dispensing member for dispensing the beverages through the outlet. Such panels may also be advantageous in providing compartments separate from the compartments containing beverages to store ice. Such a device would be a useful alternative to other such devices of the prior art. The panels of the new device may also be removable, adding versatility not found in the devices of the prior art.

### BRIEF SUMMARY OF THE INVENTION

An embodiment of the disclosure meets the needs presented above by generally comprising a container with a base wall and a perimeter wall. The perimeter wall is coupled to and extends upwardly from the base wall, and the base wall and the perimeter wall bound a chamber. The perimeter wall has a front section, a rear section, and a pair of lateral sections. A plurality of panels is coupled to the container and is positioned in the chamber. The panels of the plurality of panels are laterally spaced from each other with respect to the container and defines a plurality of slots, which includes a beverage slots each having a size such that the beverage slot is configured for containing a plurality of beverage vessels.

A support wall is coupled to the container and is positioned in the chamber above the base wall. The support wall bounds a lower compartment of the chamber below the support wall and an upper compartment of the chamber above the support wall. The support wall has an aperture extending therethrough which is in fluid communication with the beverage slot and is positioned adjacent to the front section of the perimeter wall. A dispensing member is coupled to the front section of the perimeter wall and is movable between a retracted position and an extended position with respect to the container through the front section of the perimeter wall.

The dispensing member comprises a body and a stopper. The body has a recess extending downwardly therein and is positioned under an associated aperture of the pair of apertures of the support wall when the dispensing member is positioned in the retracted position. The recess has a size such that the recess is configured to receive a selected beverage vessel of the plurality of beverage vessels through the associated aperture when the dispensing member is positioned in the retracted position. The recess is accessible from outside of the chamber when the dispensing member is positioned in the extended position. The stopper is coupled to the body and is positioned below the associated aperture when the dispensing member is positioned in the extended position. The stopper is configured to inhibit any beverage vessels of the plurality of beverage vessels from passing through the associated aperture when the dispensing member is positioned in the extended position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a dispensing cooler apparatus according to an embodiment of the disclosure with a lid and a plurality of panels removed.

FIG. 2 is an exploded front view of an embodiment of the disclosure.

FIG. 3A is a cross-section view of an embodiment of the disclosure with a dispensing member positioned in an extended position taken from Arrows 3-3 in FIG. 2.

FIG. 3B is a cross-section view of an embodiment of the disclosure with the dispensing member positioned in a retracted position taken from Arrows 3-3 in FIG. 2.

FIG. 4A is a cross-section view of an alternative embodiment of the disclosure with a dispensing member positioned in an extended position taken from Arrows 4-4 in FIG. 2.

FIG. 4B is a cross-section view of an alternative embodiment of the disclosure with the dispensing member positioned in a retracted position taken from Arrows 4-4 in FIG. 2.

FIG. 5 is a detail cross-section view of an embodiment of the disclosure taken from Circle 5 in FIG. 4A.

FIG. 6 is a detail cross-section view of an embodiment of the disclosure taken from Circle 6 in FIG. 4B.

FIG. 7 is a perspective exploded view of an embodiment of the disclosure.

FIG. 8 is a side view of an embodiment of the disclosure.

FIG. 9 is a cross-section view of an embodiment of the disclosure taken from Arrows 9-9 in FIG. 2.

FIG. 10 is a perspective in-use view of an embodiment of the disclosure.

### DETAILED DESCRIPTION OF THE INVENTION

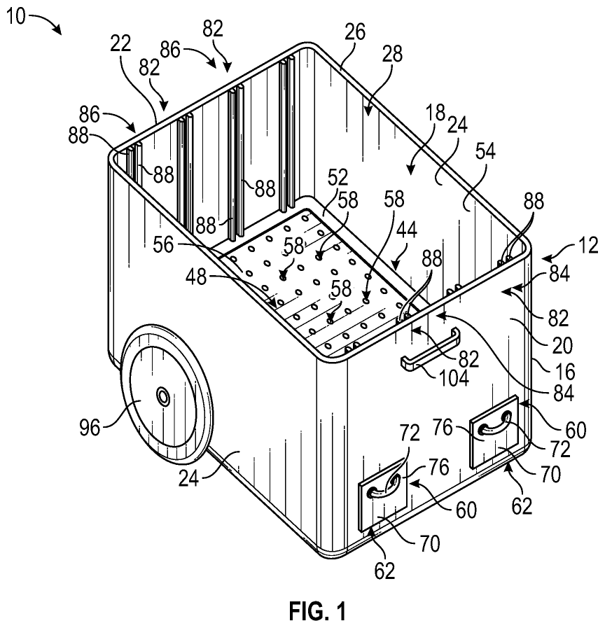

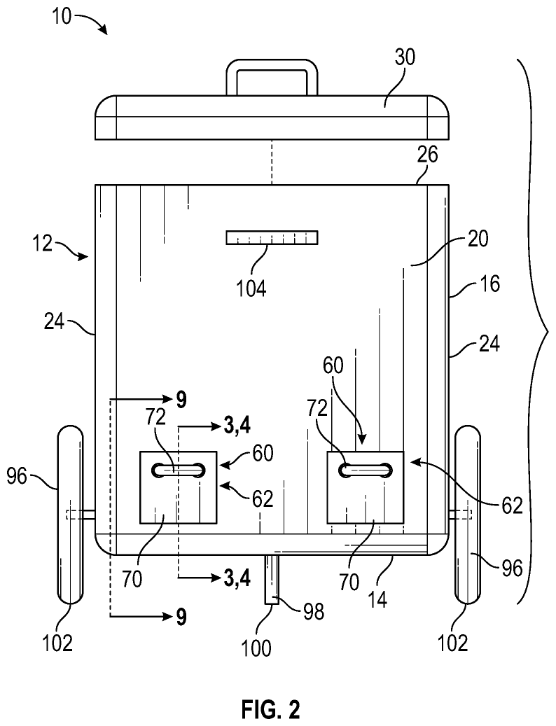

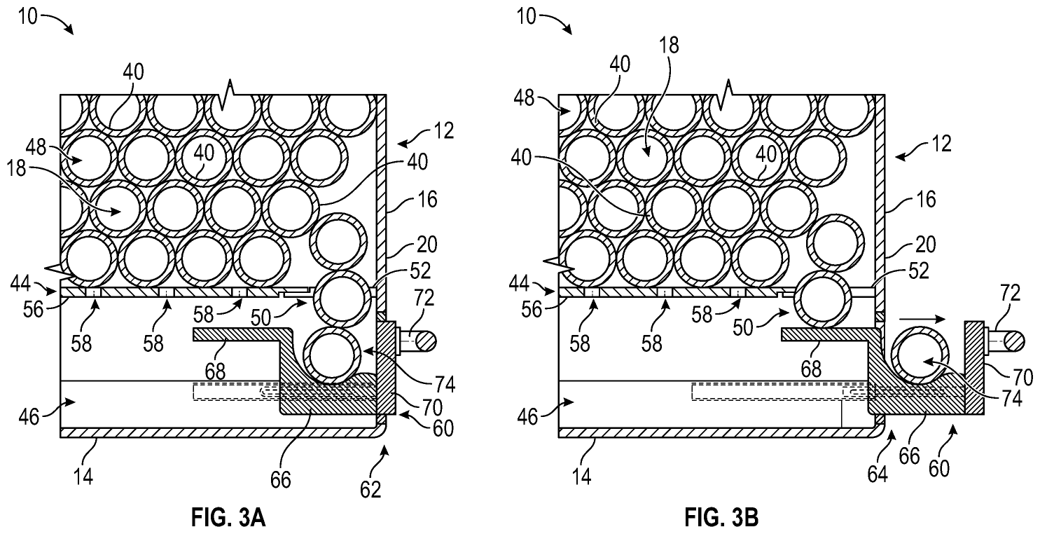

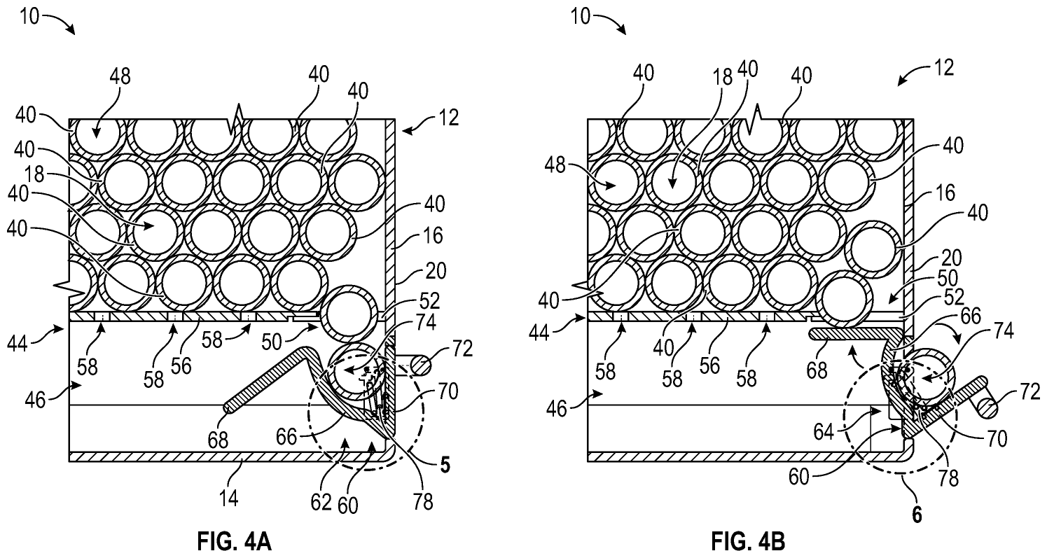

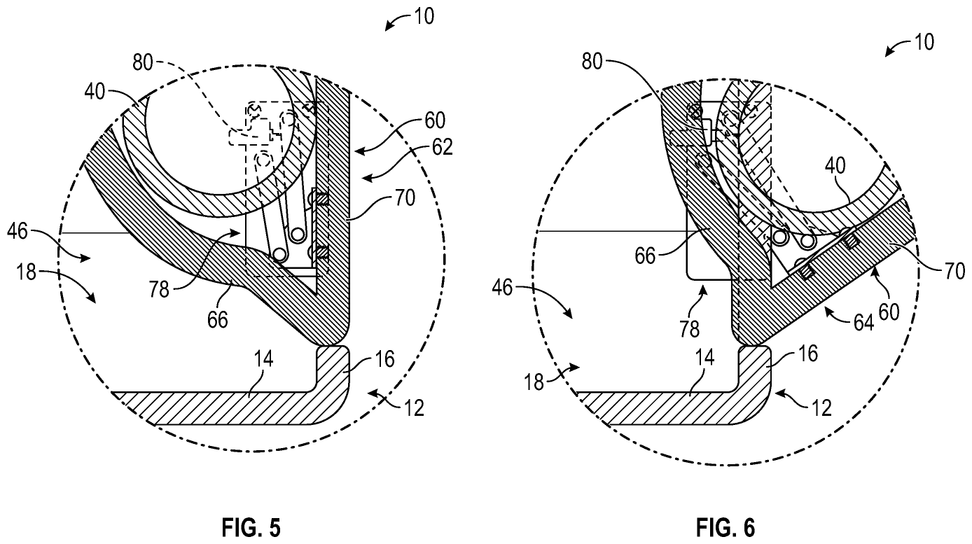

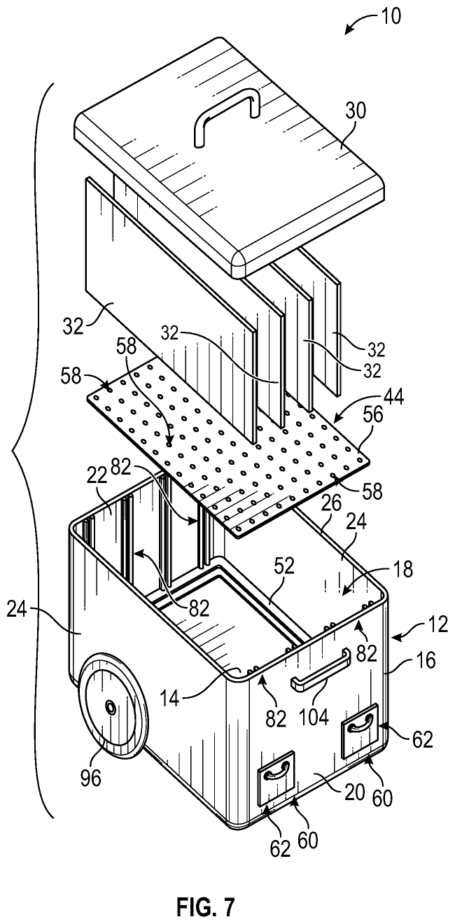

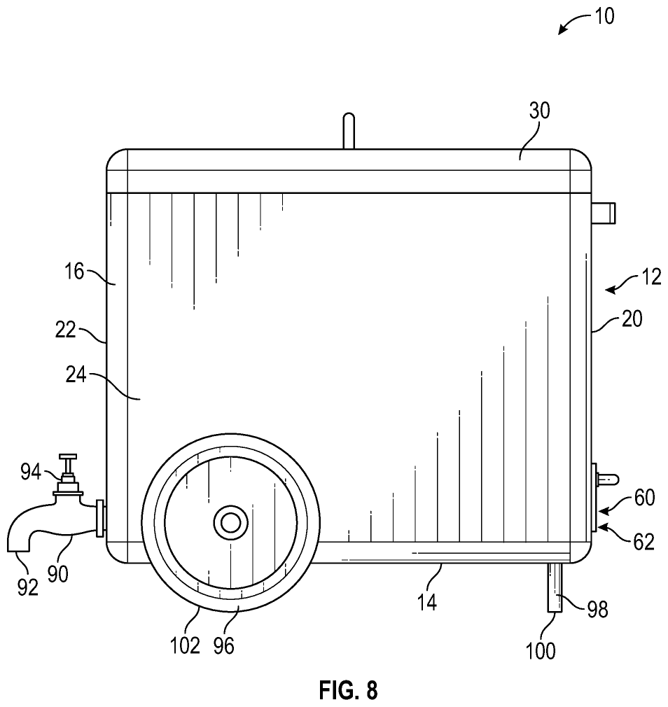

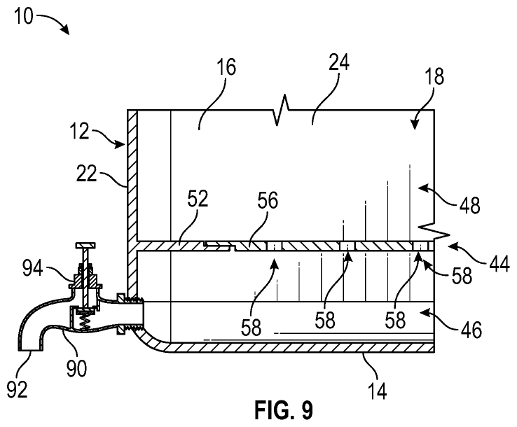

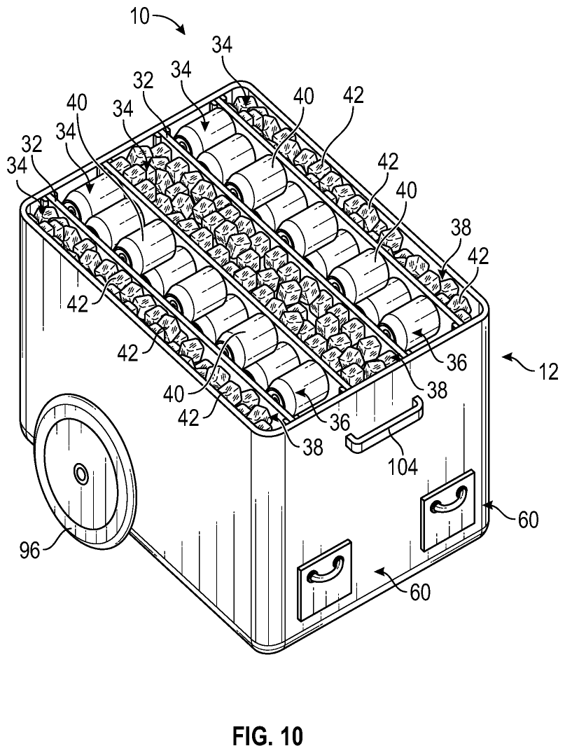

With reference now to the drawings, and in particular to FIGS. 1 through 10 thereof, a new beverage cooler embodying the principles and concepts of an embodiment of the disclosure and generally designated by the reference numeral 10 will be described.

As best illustrated in FIGS. 1 through 10, the dispensing cooler apparatus 10 generally comprises a container 12 with a base wall 14 and a perimeter wall 16. The perimeter wall 16 is coupled to and extends upwardly from the base wall 14, and the base wall 14 and the perimeter wall 16 bound a chamber 18. The perimeter wall 16 has a front section 20, a rear section 22, and a pair of lateral sections 24. An upper edge 26 of the perimeter wall 16 surrounds an opening 28 to the chamber 18, and a lid 30 is removably engaged with the upper edge 26 of the perimeter wall 16 of the container 12 to cover the opening 28. The base wall 14, the perimeter wall 16, and the lid 30 comprise a thermally insulating material.

A plurality of panels 32 is coupled to the container 12 and is positioned in the chamber 18. The panels 32 of the plurality of panels 32 are laterally spaced from each other with respect to the container 12 and define a plurality of slots 34. The plurality of slots 34 includes a pair of beverage slots 36, wherein each beverage slot 36 of the pair of beverage slots 36 has a size such that the beverage slot 36 is configured for containing an associated group of beverage vessels 40 of a plurality of beverage vessels 40. The plurality of slots 34 also includes a plurality of ice slots 38, wherein each ice slot 38 of the plurality of ice slots 38 has a size such that the ice slot 38 is configured for containing an associated group of ice cubes 42 of a plurality of ice cubes 42. Each beverage slot 36 of the pair of beverage slots 36 is positioned between an associated pair of ice slots 38 of the plurality of ice slots 38.

A support wall 44 is coupled to the container 12 and is positioned in the chamber 18 above the base wall 14. The support wall 44 bounds a lower compartment 46 of the chamber 18 below the support wall 44 and an upper compartment 48 of the chamber 18 above the support wall 44. The support wall 44 has a pair of apertures 50 extending therethrough, each of which is in fluid communication with an associated one of the pair of beverage slots 36 and is positioned adjacent to the front section 20 of the perimeter wall 16. The support wall 44 is fluid permeable such that the support wall 44 is configured for permitting drainage of the plurality of ice cubes 42 from the upper compartment 48 to the lower compartment 46 when melted. The support wall 44 comprises a ledge 52 extending along an interior side 54 of the perimeter wall 16 and a platform 56 which is removably seated on the ledge 52. The platform 56 has a plurality of drainage holes 58 extending therethrough.

A pair of dispensing members 60 is coupled to the front section 20 of the perimeter wall 16. Each dispensing member 60 of the pair of dispensing members 60 is movable between a retracted position 62 and an extended position 64 with respect to the container 12 through the front section 20 of the perimeter wall 16. Each dispensing member 60 of the pair of dispensing members 60 comprises a body 66, a stopper 68, a door 70, and a handle 72. The body 66 has a recess 74 extending downwardly therein and is positioned under an associated aperture 50 of the pair of apertures 50 of the support wall 44 when the dispensing member 60 is positioned in the retracted position 62. The recess 74 has a size such that the recess 74 is configured to receive only one beverage vessel 40 of the plurality of beverage vessels 40 through the associated aperture 50 when the dispensing member 60 is positioned in the retracted position 62. In some embodiments, however, the recess 74 may be large enough to hold multiple beverage vessels 40 of the plurality of beverage vessels 40. The recess 74 is accessible from outside of the chamber 18 when the dispensing member 60 is positioned in the extended position 64. In some embodiments, the body 66 and the recess 74 are positioned outside of the chamber 18 when the dispensing member 60 is in the extended position 64. In other embodiments, the body 66 and the recess 74 remain in the chamber 18 but are oriented to be accessible through an outlet in the perimeter wall 16 when the dispensing member 60 is in the extended position 64.

The stopper 68 is coupled to the body 66 and is positioned below the associated aperture 50 when the dispensing member 60 is positioned in the extended position 64. The stopper 68 is configured to inhibit any beverage vessels 40 of the plurality of beverage vessels 40 from passing through the associated aperture 50 when the dispensing member 60 is positioned in the extended position 64. The door 70 is coupled to the body 66 opposite the stopper 68 and forms a seal with the front section 20 of the perimeter wall 16 when the dispensing member 60 is positioned in the retracted position 62. The handle 72 is coupled to a front surface 76 of the door 70 to facilitate gripping and moving the dispensing member 60.

In some embodiments, each dispensing member 60 of the pair of dispensing members 60 is slidably coupled to the container 12 such that the dispensing member 60 is slidable between the retracted position 62 and the extended position 64. In other embodiments, each one of a pair of linkages 78 is coupled to the container 12 and an associated one of the pair of dispensing members 60 such that the dispensing member 60 is pivotable between the retracted position 62 and the extended position 64. In such embodiments, each one of the pair of linkages 78 comprises a biasing member 80 for biasing the associated dispensing member 60 toward the retracted position 62.

A plurality of receivers 82 is coupled to the container 12. The plurality of receivers 82 includes a plurality of front receivers 84 positioned on the front section 20 of the perimeter wall 16 and a plurality of rear receivers 86 positioned on the rear section 22 of the perimeter wall 16. Each receiver 82 of the plurality of receivers 82 releasably engages an associated one of the plurality of panels 32. Each front receiver 84 of the plurality of front receivers 84 is positioned opposite an associated rear receiver 86 of the plurality of rear receivers 86. The plurality of receivers 82 is defined by rails 88 extending from the perimeter wall 16.

A drain tube 90 is coupled to the container 12 and is in fluid communication with the lower compartment 46 of the chamber 18. A distal end 92 of the drain tube 90 with respect to the container 12 is open. A valve 94 is coupled to the drain tube 90 and is movable between an open position and a closed position, wherein the valve 94 permits fluid flow from the lower compartment 46 to outside of the chamber 18 only when the valve 94 is open. A pair of wheels 96 is mounted to the container 12, each of which is positioned on an associated one of the pair of lateral sections 24 of the perimeter wall 16 and adjacent to the rear section 22 of the perimeter wall 16. A stand 98 is coupled to and extends downwardly from the container 12 and is positioned adjacent to the front section 20 of the perimeter wall 16. A lower end 100 of the stand 98 lies on a shared plane with a lower extent 102 of each wheel 96 of the pair of wheels 96, wherein the shared plane is oriented parallel to the base wall 14. A towing handle 104 is coupled to the front section 20 of the perimeter wall 16 of the container 12 to facilitate towing the container 12.

In use, the plurality of beverage vessels 40 is inserted into the pair of beverage slots 36 and the plurality of ice cubes 42 are inserted into the plurality of ice slots 38. Other conventional heat transfer media may be used in the plurality of ice slots 38 such as an enclosed receptacle holding ice, a refrigerant gel, or the like. Other items may also be placed in the beverage slots 36 such as cans of food or the like. Gravity acts on the plurality of beverage vessels 40 to urge beverage vessels 40 through an associated one of the pair of apertures 50 and into the recess 74 of the body 66 of the dispensing member 60. To dispense the selected beverage vessel 40, one of the dispensing members 60 is moved to the extended position 64 so that the selected beverage vessel 40 is accessible from outside of the chamber 18. Then the one dispensing member 60 is moved into the retracted position 62 to receive another beverage vessel 40 into the recess 74. The plurality of panels 32 may be removed from the chamber 18 to make room for items that do not fit in the beverage slots 36 and to use the dispensing cooler apparatus 10 without dispensing items through the dispensing members 60. The platform 56 of the support wall 44 may also be removed to make the lower compartment 46 available for additional storage space in the container 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dispensing cooler apparatus comprising:
a container having a base wall and a perimeter wall, the perimeter wall being coupled to and extending upwardly from the base wall, the base wall and the perimeter wall bounding a chamber, the perimeter wall having a front section, a rear section, and a pair of lateral sections;
a plurality of panels being coupled to the container and being positioned in the chamber, the plurality of panels being laterally spaced from each other with respect to the container and defining a plurality of slots, the plurality of slots including a beverage slots, the beverage slot having a size such that the beverage slot is configured for containing a plurality of beverage vessels;
a support wall being coupled to the container and being positioned in the chamber above the base wall, the support wall bounding a lower compartment of the chamber below the support wall and an upper compartment of the chamber above the support wall, the support wall having an aperture extending therethrough, the aperture being in fluid communication with the beverage slot and being positioned adjacent to the front section of the perimeter wall; and
a dispensing member being coupled to the front section of the perimeter wall, the dispensing member being movable between a retracted position and an extended position with respect to the container through the front section of the perimeter wall, the dispensing member comprising:
a body having a recess extending downwardly therein, the body being positioned under an associated aperture of the pair of apertures of the support wall when the dispensing member is positioned in the retracted position, the recess having a size such that the recess is configured to receive a selected beverage vessel of the plurality of beverage vessels through the associated aperture when the dispensing member is positioned in the retracted position, the recess being accessible from outside of the chamber when the dispensing member is positioned in the extended position; and
a stopper being coupled to the body and being positioned below the associated aperture when the dispensing member is positioned in the extended position, the stopper being configured to inhibit any beverage vessels of the plurality of beverage vessels from passing through the associated aperture when the dispensing member is positioned in the extended position.

2. The apparatus of claim 1, wherein the base wall, the perimeter wall, and the lid comprise a thermally insulating material.

3. The apparatus of claim 1, wherein the plurality of slots includes a pair of ice slots, each ice slot of the pair of ice slots having a size such that the ice slot is configured for containing an associated group of ice cubes of a plurality of ice cubes, the beverage slot being positioned between the pair of ice slots.

4. The apparatus of claim 3, wherein the support wall is fluid permeable such that the support wall is configured for permitting drainage of the plurality of ice cubes from the upper compartment to the lower compartment when melted.

5. The apparatus of claim 1, wherein the support wall comprises a ledge extending along an interior side of the perimeter wall and a platform being removably seated on the ledge.

6. The apparatus of claim 5, wherein the platform has a plurality of drainage holes extending therethrough.

7. The apparatus of claim 1, wherein the recess in the body of the dispensing member has a size such that the recess is configured to receive only one beverage vessel of the plurality of beverage vessels through the associated aperture when the dispensing member is positioned in the retracted position.

8. The apparatus of claim 1, wherein the dispensing member further comprises a door being coupled to the body opposite the stopper, the door forming a seal with the front section of the perimeter wall when the dispensing member is positioned in the retracted position.

9. The apparatus of claim 8, wherein the dispensing member further comprises a handle being coupled to a front surface of the door.

10. The apparatus of claim 1, further comprising a plurality of receivers being coupled to the container, the plurality of receivers including a plurality of front receivers positioned on the front section of the perimeter wall and a plurality of rear receivers being positioned on the rear section of the perimeter wall, each receiver of the plurality of receivers releasably engaging an associated one of the plurality of panels, each front receiver of the plurality of front receivers being positioned opposite an associated rear receiver of the plurality of rear receivers.

11. The apparatus of claim 10, wherein the plurality of receivers is defined by rails extending from the perimeter wall.

12. The apparatus of claim 1, further comprising:
a drain tube being coupled to the container, the drain tube being in fluid communication with the lower compartment of the chamber, a distal end of the drain tube with respect to the container being open; and
a valve being coupled to the drain tube, the valve being movable between an open position and a closed position, wherein the valve permits fluid flow from the lower compartment to outside of the chamber only when the valve is open.

13. The apparatus of claim 1, further comprising a pair of wheels being mounted to the container, each wheel of the pair of wheels being positioned on an associated one of the pair of lateral sections of the perimeter wall and adjacent to the rear section of the perimeter wall.

14. The apparatus of claim 13, further comprising a stand being coupled to and extending downwardly from the container, the stand being positioned adjacent to the front section of the perimeter wall, a lower end of the stand lying on a shared plane with a lower extent of each wheel of the pair of wheels, the shared plane being oriented parallel to the base wall.

15. The apparatus of claim 13, further comprising a towing handle being coupled to the front section of the perimeter wall of the container.

16. The apparatus of claim 1, wherein the dispensing member is slidably coupled to the container such that the dispensing member is slidable between the retracted position and the extended position.

17. The apparatus of claim 1, further comprising a linkage being coupled to the container and the dispensing member such that the dispensing member is pivotable between the retracted position and the extended position, each one of the pair of linkages comprising a biasing member for biasing the associated dispensing member toward the retracted position.

18. A dispensing cooler apparatus comprising:
a container having a base wall and a perimeter wall, the perimeter wall being coupled to and extending upwardly from the base wall, the base wall and the perimeter wall bounding a chamber, the perimeter wall having a front section, a rear section, and a pair of lateral sections, an upper edge of the perimeter wall surrounding an opening to the chamber, the base wall and the perimeter wall comprising a thermally insulating material;
a plurality of panels being coupled to the container and being positioned in the chamber, the plurality of panels being laterally spaced from each other with respect to the container and defining a plurality of slots, the plurality of slots including a pair of beverage slots, each beverage slot of the pair of beverage slots having a size such that the beverage slot is configured for containing an associated group of beverage vessels of a plurality of beverage vessels, the plurality of slots including a plurality of ice slots, each ice slot of the plurality of ice slots having a size such that the ice slot is configured for containing an associated group of ice cubes of a plurality of ice cubes, each beverage slot of the pair of beverage slots being positioned between an associated pair of ice slots of the plurality of ice slots;
a support wall being coupled to the container and being positioned in the chamber above the base wall, the support wall bounding a lower compartment of the chamber below the support wall and an upper compartment of the chamber above the support wall, the support wall having a pair of apertures extending therethrough, each aperture of the pair of apertures being in fluid communication with an associated one of the pair of beverage slots and being positioned adjacent to the front section of the perimeter wall, the support wall being fluid permeable such that the support wall is configured for permitting drainage of the plurality of ice cubes from the upper compartment to the lower compartment when melted, the support wall comprising a ledge extending along an interior side of the perimeter wall and a platform being removably seated on the ledge, the platform having a plurality of drainage holes extending therethrough;
a pair of dispensing members being coupled to the front section of the perimeter wall, each dispensing member of the pair of dispensing members being movable between a retracted position and an extended position with respect to the container through the front section of the perimeter wall, each dispensing member of the pair of dispensing members comprising:
a body having a recess extending downwardly therein, the body being positioned under an associated aperture of the pair of apertures of the support wall when the dispensing member is positioned in the retracted position, the recess having a size such that the recess is configured to receive only one beverage vessel of the plurality of beverage vessels through the associated aperture when the dispensing member is positioned in the retracted position, the recess being accessible from outside of the chamber when the dispensing member is positioned in the extended position;
a stopper being coupled to the body and being positioned below the associated aperture when the dispensing member is positioned in the extended position, the stopper being configured to inhibit any beverage vessels of the plurality of beverage vessels from passing through the associated aperture when the dispensing member is positioned in the extended position;
a door being coupled to the body opposite the stopper, the door forming a seal with the front section of the perimeter wall when the dispensing member is positioned in the retracted position; and
a handle being coupled to a front surface of the door;
a lid being removably engaged with the upper edge of the perimeter wall of the container to cover the opening, the lid comprising the thermally insulating material;
a plurality of receivers being coupled to the container, the plurality of receivers including a plurality of front receivers positioned on the front section of the perimeter wall and a plurality of rear receivers being positioned on the rear section of the perimeter wall, each receiver of the plurality of receivers releasably engaging an associated one of the plurality of panels, each front receiver of the plurality of front receivers being positioned opposite an associated rear receiver of the plurality of rear receivers, the plurality of receivers being defined by rails extending from the perimeter wall;
a drain tube being coupled to the container, the drain tube being in fluid communication with the lower compartment of the chamber, a distal end of the drain tube with respect to the container being open;
a valve being coupled to the drain tube, the valve being movable between an open position and a closed position, wherein the valve permits fluid flow from the lower compartment to outside of the chamber only when the valve is open;
a pair of wheels being mounted to the container, each wheel of the pair of wheels being positioned on an associated one of the pair of lateral sections of the perimeter wall and adjacent to the rear section of the perimeter wall;
a stand being coupled to and extending downwardly from the container, the stand being positioned adjacent to the front section of the perimeter wall, a lower end of the stand lying on a shared plane with a lower extent of each wheel of the pair of wheels, the shared plane being oriented parallel to the base wall; and
a towing handle being coupled to the front section of the perimeter wall of the container.

19. The apparatus of claim 18, wherein each dispensing member of the pair of dispensing members is slidably coupled to the container such that the dispensing member is slidable between the retracted position and the extended position.

20. The apparatus of claim 18, further comprising a pair of linkages, each linkage of the pair of linkages being coupled to the container and an associated one of the pair of dispensing members such that the dispensing member is pivotable between the retracted position and the extended position, each one of the pair of linkages comprising a biasing member for biasing the associated dispensing member toward the retracted position.
